(19) United States
(12) Patent Application Publication
(10) Pub. No.: US 2006/0177052 A1
(43) Pub. Date: Aug. 10, 2006

(54) S-box encryption in block cipher implementations

(76) Inventor: Gerardus T.M. Hubert, Geldrop (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/515,147

(22) PCT Filed: May 15, 2003
(86) PCT No.: PCT/IB03/02073

§ 371 Date: Nov. 19, 2004

(30) Foreign Application Priority Data
May 23, 2002 (GB) 02111812.3

(51) Int. Cl. H04L 9/06

(52) U.S. Cl. 380/29

(57) ABSTRACT

A method of performing encryption or decryption in a cryptographic engine that implements a cryptographic algorithm reduces the risk of differential power analysis revealing key information from inputs and output from S-boxes. The data and address locations used to access the data in S-boxes are encrypted. Retrieval of data from the encrypted S-boxes is effected by performing an address modification function to modify an input address used for a look-up operation to said S-box, and performing a data modification function for modifying data output from said S-box as a result of said look-up operation, the address modification function and the data modification function being selected to compensate for the encryption of the S-box. The S-box encryption and modification functions are periodically updated.

The present invention relates to encryption and decryption techniques using block ciphers, and in particular to the implementation of S-boxes therein. The invention has particular, though not exclusive, application in cryptographic devices such as those installed in smart cards and other devices, which may be particularly vulnerable to cryptanalysis techniques such as differential power analysis, for obtaining side channel information during operation of the device.

Many cryptographic devices are implemented using microprocessors and associated logic on devices such as smart cards. A number of power analysis techniques are widely available to obtain data from the smart card that would otherwise, in the course of normal input and output operations, be securely encrypted. In particular, analysis of the power consumption of the logic performing an encryption or decryption operation may be used to establish the round keys used in the encryption or decryption operation, for example as described in Kocher et al: “Differential Power Analysis”, www.cryptography.com and Messerges et al: “Investigations of Power analysis Attacks on Smartcards”, Proceedings of USENIX Workshop on Smartcard Technology, May 1999, pp. 151-161.

In particular, the “look-up” operations accessing S-boxes used in the Data Encryption Standard (DES) and Advanced Encryption Standard (AES) block ciphers are particularly vulnerable to power analysis techniques, and the use of S-boxes is difficult to protect against defined side channel attacks, owing to their non-linear character.

In the prior art, WO 00/46953 has proposed splitting the S-boxes into two parts, but in certain applications such as implementations of the cryptographic device on a smart card, this requires more memory than is sometimes readily available or desirable.

It is an object of the present invention to provide an encryption and decryption technique generally applicable to block ciphers which renders the cryptographic logic circuit performing the cryptographic operations, and especially the S-boxes, less vulnerable to power analysis attacks.

According to one aspect, the present invention provides a method of performing encryption and/or decryption in a cryptographic engine implementing a cryptographic algorithm, comprising the steps of:

retrieving data from an encrypted S-box, by performing an address modification function to modify an input address used for a look-up operation to said S-box, and performing a data modification function for modifying data output from said S-box as a result of said look-up operation, the address modification function and the data modification function being selected to compensate for the encryption of the S-box.

According to another aspect, the present invention provides a method of performing encryption and/or decryption in a cryptographic engine implementing a cryptographic algorithm, comprising the steps of:
a) encrypting the data and address locations used to access said data in an S-box;
b) defining a corresponding address modification function and a data modification function to compensate for the encryption of data and address locations in the S-box;
c) retrieving data from the encrypted S-box, using said address modification function to modify an input address used for a look-up operation to said S-box, and performing the data modification function for modifying data output from said S-box as a result of said look-up operation; and
d) periodically repeating steps a)-c) with new encryption functions.

According to another aspect, the present invention provides a cryptographic engine comprising:

an encrypted S-box providing predetermined data output as a function of input values, in accordance with a predetermined cryptographic transform, superimposed with an encryption function;

means for retrieving data from the encrypted S-box, by performing an address modification function to modify an input address used for a look-up operation to said S-box, and

means for performing a data modification function for modifying data output from said S-box as a result of said look-up operation, the address modification function and the data modification function being selected to compensate for the encryption of the S-box.

Embodiments of the present invention will now be described by way of example and with reference to the accompanying drawings in which:

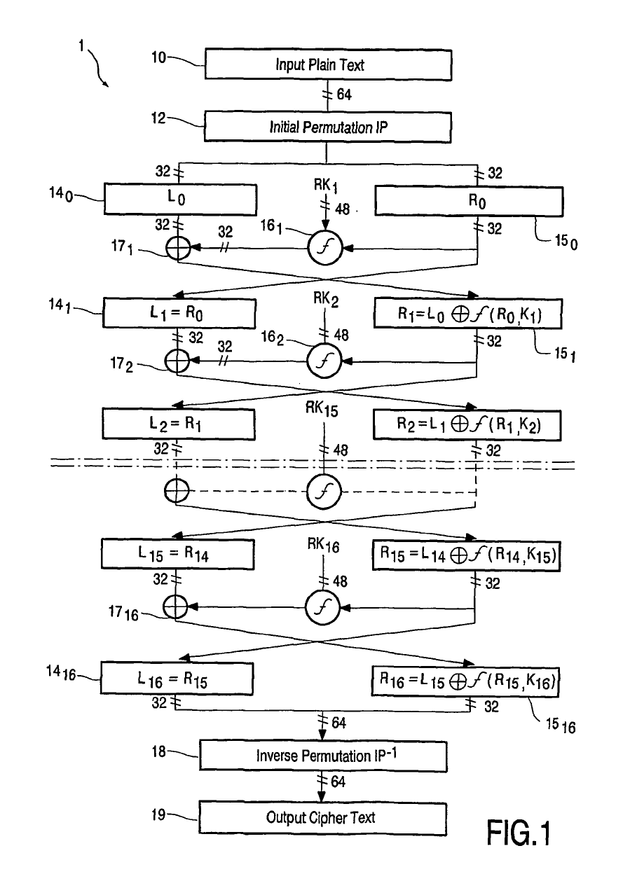

FIG. 1 is a flow diagram illustrating implementation of an encryption operation using the DES block cipher algorithm;

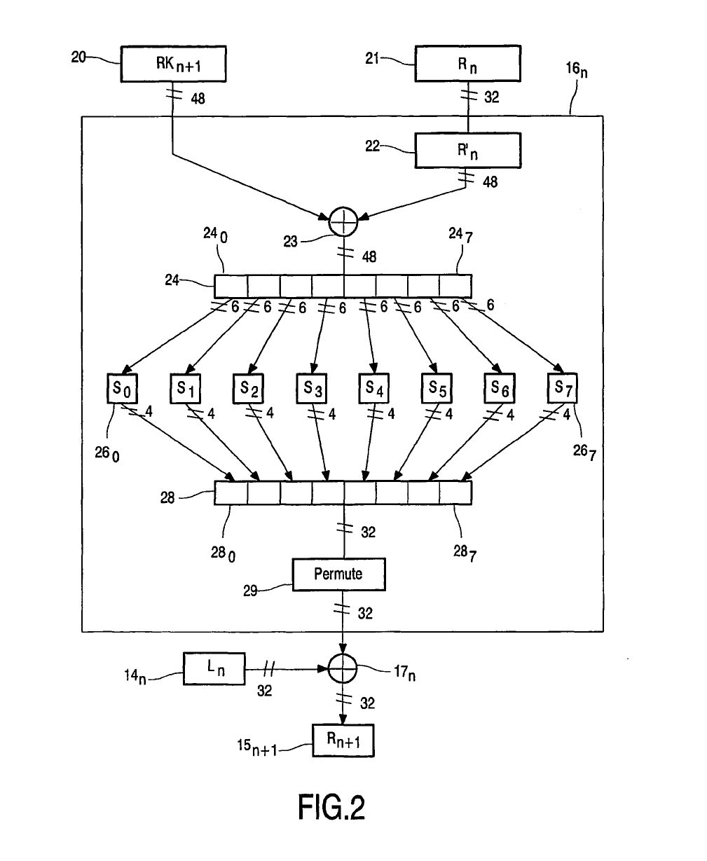

FIG. 2 is a detailed flow diagram illustrating the S-box look-up operation deployed in the procedure of FIG. 1;

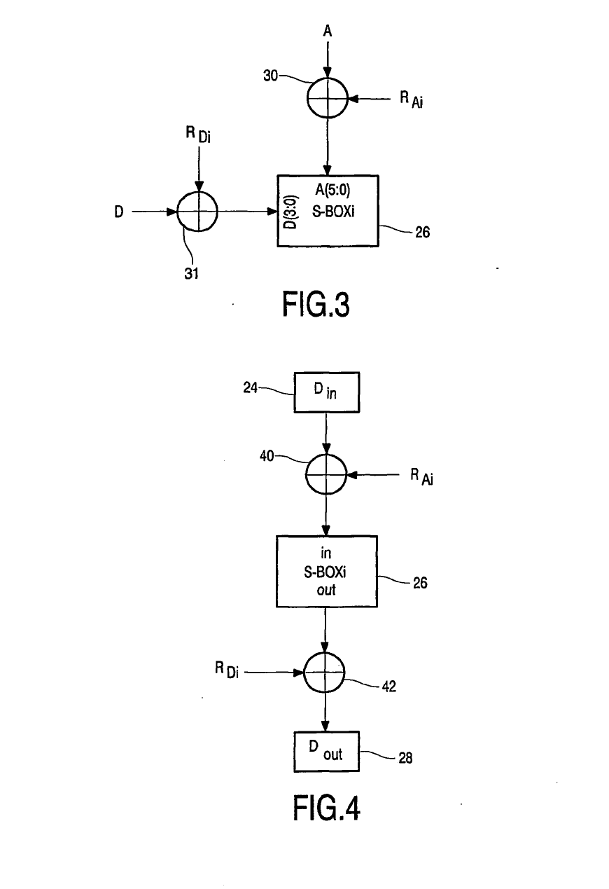

FIG. 3 is a schematic diagram illustrating the loading of an S-box;

FIG. 4 is a schematic diagram illustrating the look-up operation on an S-box;

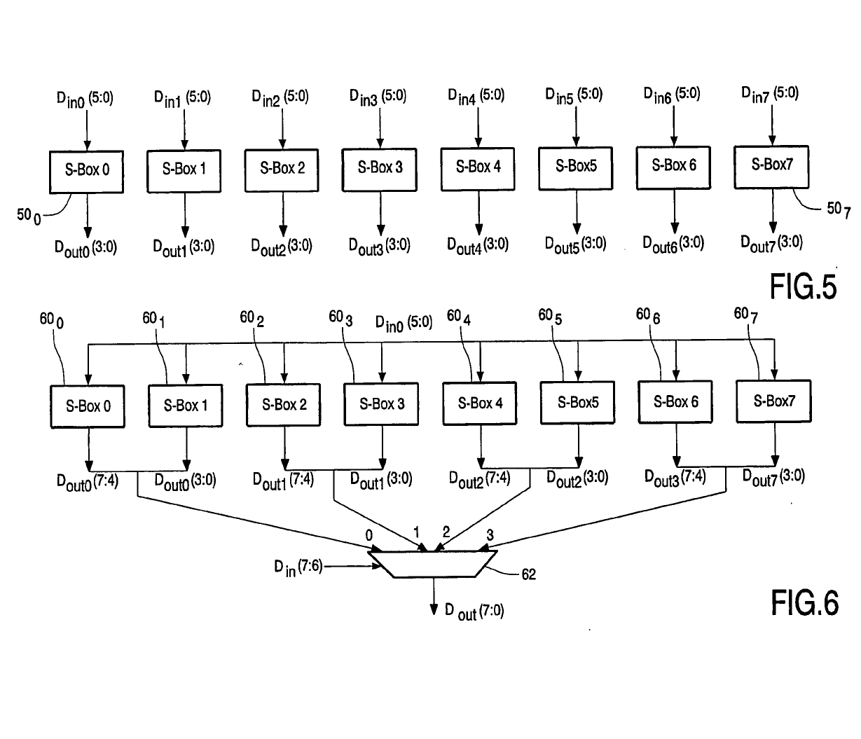

FIG. 5 is a schematic diagram of the S-box configuration for the DES algorithm implementation of FIG. 1;

FIG. 6 is a schematic diagram of the S-box configuration for the AES block cipher algorithm;

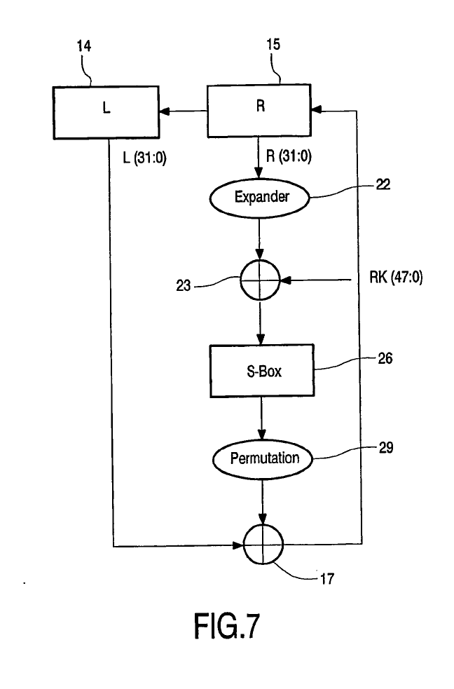

FIG. 7 is a detailed flow diagram illustrating a conventional encryption round in the DES encryption procedure of FIG. 1;

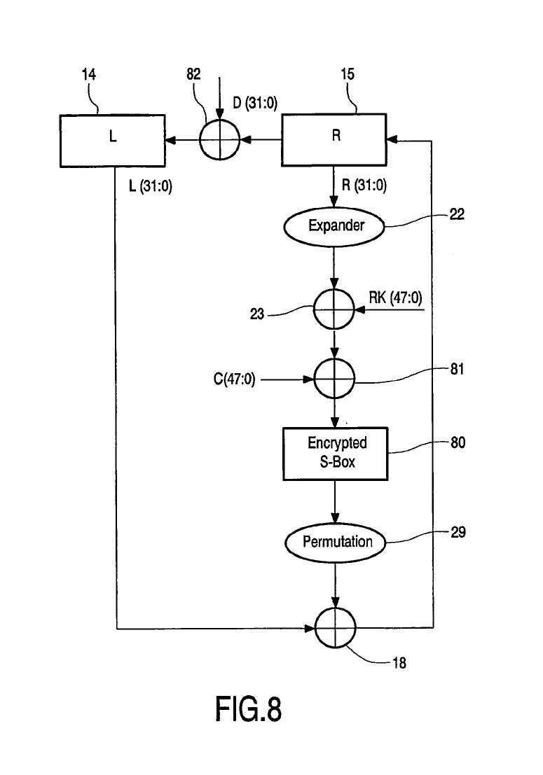

FIG. 8 is a detailed flow diagram illustrating a DES encryption round modified according to one embodiment of the present invention;

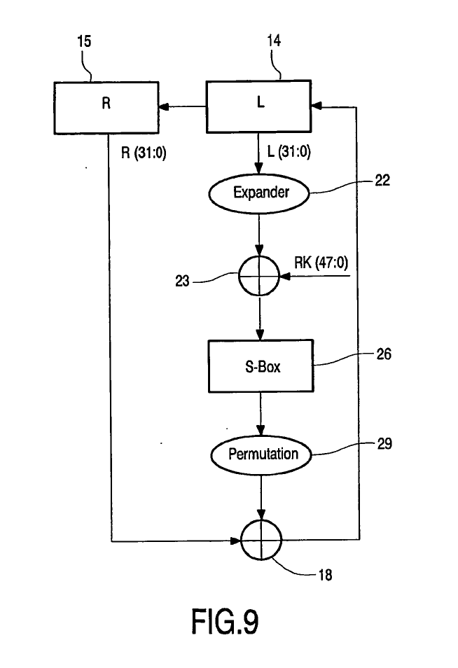

FIG. 9 is a detailed flow diagram illustrating a conventional decryption round in the DES decryption procedure;

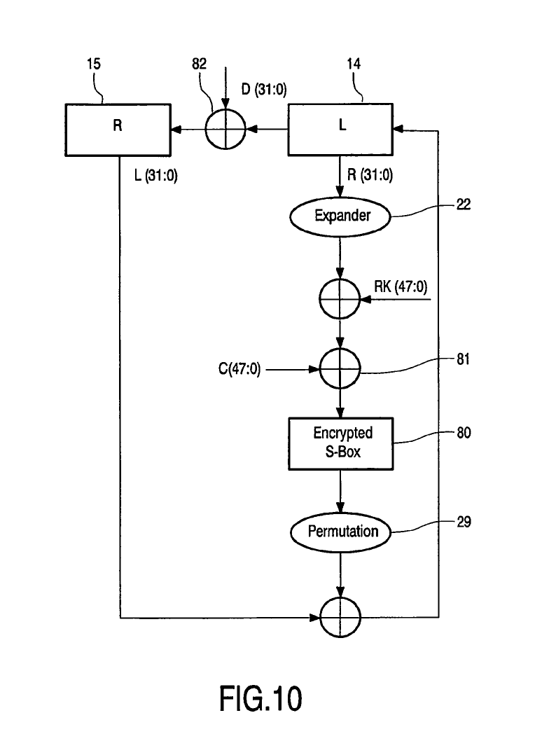

FIG. 10 is a detailed flow diagram illustrating a DES decryption round modified according to one embodiment of the present invention;

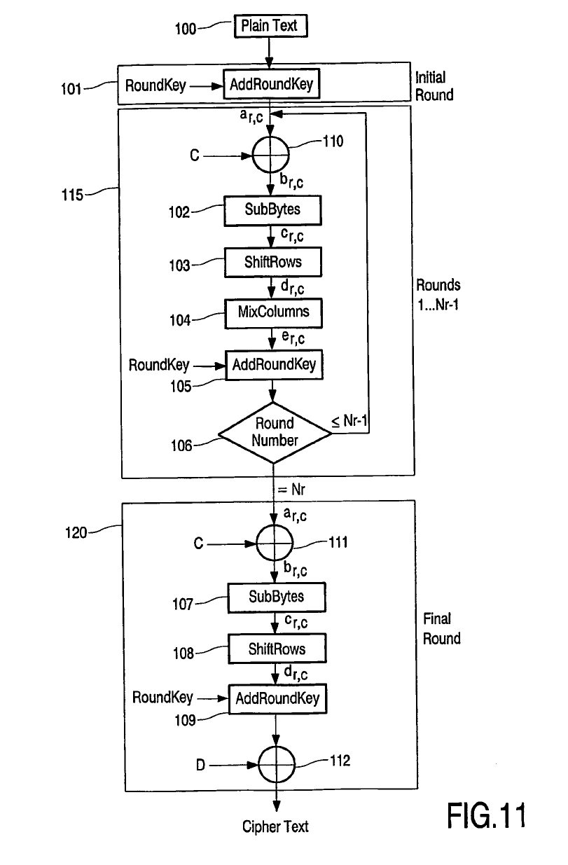

FIG. 11 is a schematic diagram illustrating the AES encryption operations modified according to one embodiment the present invention;

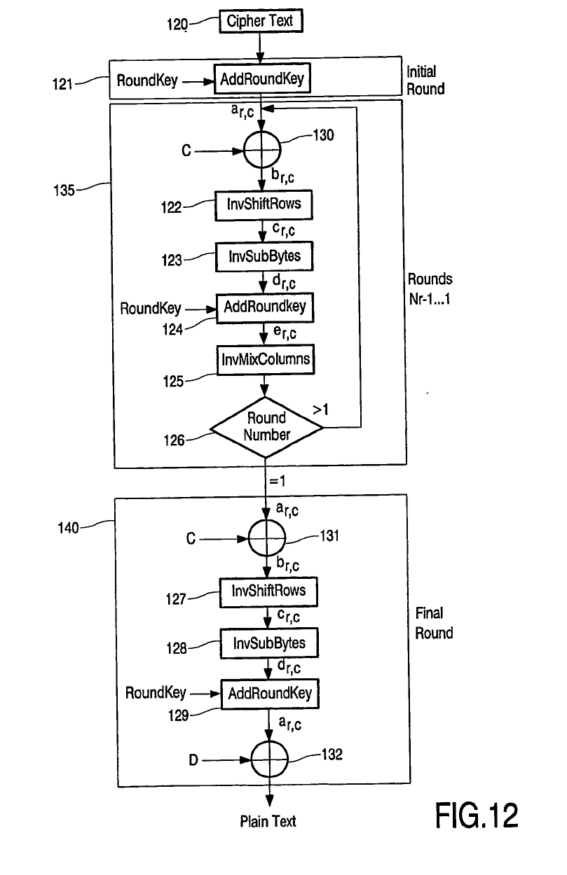

FIG. 12 is a schematic diagram illustrating the AES decryption operations modified according to one embodiment of the present invention; and

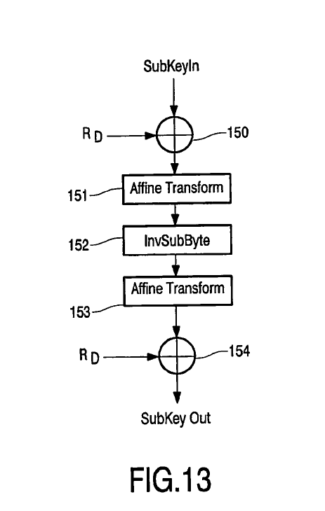

FIG. 13 is a schematic diagram of a key scheduling operation.

### DES ALGORITHM IMPLEMENTATION

A first detailed implementation of the present invention will now be described in the context of the DES block cipher, which is represented schematically in flow diagram form in FIG. 1. In the figure, the information flow lines indicate the number of data bits transferred in each information flow.

The DES block cipher receives plaintext blocks 10 each of 64 bits. Each 64-bit block 10 undergoes an initial permutation (IP) function 12 in which predetermined bits are moved to predetermined new bit positions. The output from this operation is divided into two 32-bit blocks 14₀ and 15₀, respectively referred to as the left block L and right block R. In the first round, these blocks are indicated as L₀ and R₀.

There are then sixteen sequential rounds of operation on the left and right blocks, L and R. In each round, the right block R is transferred unchanged to the left block of the new round, eg. to L₁ at 14₁.

The right block is also used to generate a transformation in the left block. To this end, the 32 bits of the right block R₀ are combined with a first key RK₁ in a cipher function operation f, at 16₁, that will be described in greater detail with reference to FIG. 2. The 32-bit output of that cipher function operation f is combined in an XOR operation 17₁ with the 32 bits of the left block L₀ to form the new right block R₁ at 15₁.

The procedure is repeated over sixteen rounds for left and right blocks starting at 14₀, 15₀ through to 14₁₆ and 15₁₆. In each round, a different 48 bit key RK₁ to RK₁₆ is used, derived from a 64 bit DES key according to a key schedule algorithm.

At the end of the sixteen rounds, the left and right blocks L₁₆ and R₁₆ at 14₁₆ and 15₁₆ are recombined into a 64-bit block at 18, where the inverse of the initial permutation function, IP⁻¹ rearranges the bits of the block into the final cipher text output block 19.

With reference to FIG. 2, the implementation of the cipher function f, at 16¹ to 16ₙ will now be described.

The 32-bit right block Rₙ shown at 21 is expanded to a 48-bit block R′ₙ shown at 22, simply by duplication of certain predetermined bit positions. The 48 bit round key RKₙ₊₁ shown at 20 is then combined with the expanded right block 21 in XOR function 23 to generate a 48-bit output value 24. This output value is divided into eight 6-bit blocks, 24₀ . . . 24₇. Each of the 6-bit blocks is used as input to a respective S-box (look-up table) 26₀ to 26₇ to generate a respective 4-bit output 28₀ to 28₇ which outputs are combined to form a 32-bit block 28. Block 28 is input to a predetermined permutation function 29 to generate the 32-bit output that is combined with Lₙ (block 14ₙ in FIG. 1) in the XOR function 18ₙ to generate right block Rₙ₊₁ (block 15ₙ₊₁) in FIG. 1).

In many hardware implementations of the DES algorithm, the S-boxes are downloadable from time to time from ROM or flash memory into the encryption engine. The present invention provides for encryption of the downloaded S-boxes S₀ to S₇.

With reference to FIG. 3, each time the S-boxes 26 are downloaded from ROM to the encryption engine, the address of the look-up table is XOR-combined with a random value R_{Ai} and the data downloaded is XOR-combined with a random value R_{Di}. As seen in FIG. 2, each S-box address is 6-bits, and each data output is 4-bits. Thus, for all eight S-boxes combined, the R_{Ai} values are 48-bits wide, referred to as R_{A} and the R_{Di} values are 32 bits wide, referred to as R_{D}. Thus, it will be recognised that both the data position in the S-box, and its value, have been encrypted.

Thus, in a general aspect, the data stored in the S-box are modified according to a data modification function, and the address of the data is modified according to an address modification function. In the preferred embodiments, the data modification function comprises XOR-combination of the data with a predetermined random value. In the preferred embodiments, the address modification function comprises XOR-combination of the address with a predetermined random value.

To recover data from the encrypted S-boxes, during the look up operation in FIG. 2, the address values 24₀ to 24₇ must first be XOR-combined with the respective random value R_{Ai} and the data output value 28₀ to 28₇ must be XOR-combined with the respective random value R_{Di} to give the same result as a conventional S-box. This operation is illustrated in FIG. 4.

Thus, in a general aspect, during look-up operations, the address values for look-up are modified according to an address modification function, and the data output from the look-up operation are modified according to a data modification function. In the preferred embodiments, the data modification function comprises XOR-combination of the data output with a predetermined random value. In the preferred embodiments, the address modification function comprises XOR-combination of the address input with a predetermined random value.

In the preferred embodiments of the invention, however, the XOR functions (or other modification functions) are not applied directly at the input and/or the output of the S-box, but at other positions in order to ensure that the contents of the registers and logic in the encryption engine will change when the S-boxes have been reloaded.

FIG. 7 shows a simplified illustration of the conventional DES encryption round. Registers 14, 15 each contain 32 bits. R is expanded into 48 bits in the expander 22 and XOR-combined with the 48-bit round key RKₙ for that round. This is input to the 8 unencrypted S-boxes 26. The 32-bit output of the unencrypted S-boxes are permuted 29 and then XOR-combined with the contents of L register 14 to derive the new value of R for the next round. The old value of R in register 15 is shifted into the L register 14 for the next round.

By comparison, FIG. 8 shows the DES encryption round modified according to one embodiment of the present invention. In this arrangement, the S-boxes 80 were encrypted during the loading thereof according to the procedure described in connection with FIG. 3. To compensate for the encryption of the S-box 80, an additional address modification function 81 is inserted at the input to the encrypted S-box 80. However, unlike the encrypted S-box look-up method described in connection with FIG. 4, in this arrangement, the data output from the encrypted S-box are not immediately decrypted by the data modification function. The data modification function 82 is inserted after the permutation function 29, on transfer of the R data block in register 15 to the L data block in register 14.

The address modification function 81 may instead be inserted between the Key Memory itself and the Round Key Generator, which will also protect the generation of the Round Key.

In the scheme of FIG. 8, the data values R_{Ai} and R_{Di} (FIG. 3) used for the address modification function and the data modification function respectively are replaced by data values C and D respectively, for all i (ie. 8 S-boxes). The values for C and D are selected to compensate for the delay of the data modification function 82 into the subsequent round.

R_{D} is a 32-bit random value. First, we choose R_{A}=Expd (Perm(R_{D})), where Expd is the DES expansion function 22 (FIG. 2) and Perm is the permutation function 29 (FIG. 2). This operation requires no further hardware because the permutation function is simply interchanging bits and the expansion function is simply duplication of selected data bits.

C and D are preferably chosen such that the L and R registers 14, 15 always differ by a random value from the standard DES (except for the first and last round). This means that when these data values are changed in a subsequent block encryption, the contents of the R and L registers will differ from previous block encryption operations. Also, the outputs of the other logic elements will differ. This makes a direct side-channel attack on the encryption system very difficult or impossible, providing that the random constant R_{D} is changed from time to time.

Table 1 below gives exemplary values for C and D per round of encryption. The columns Lₙ⊕LNₙ and Rₙ⊕RNₙ indicate the difference between the contents of the registers L and R compared to an implementation of the standard DES algorithm. Note the 4-round repetition, except for the beginning and the end.

TABLE 1
Selection of constants C and D

| Round | | | | |
|---|---|---|---|---|
| n | Cₙ | Dₙ | Lₙ ⊕ lNₙ | Rₙ ⊕ RNₙ |
| 0 | Expd(Perm(R_{D})) | R_{D} | 0 | 0 |
| 1 | 0 | R_{D} | R_{D} | Perm(R_{D}) |
| 2 | Expd(R_{D}) | 0 | R_{D} ⊕ Perm(R_{D}) | R_{D} ⊕ |
| | | | | Perm(R_{D}) |
| 3 | Expd(R_{D} ⊕ Perm(R_{D}) | 0 | R_{D} ⊕ Perm(R_{D}) | R_{D} |
| 4 | Expd(R_{D} ⊕ Perm(R_{D}) | 0 | R_{D} | R_{D} |
| 5 | ExpdR_{D} | 0 | R_{D} | R_{D} ⊕ |
| | | | | Perm(R_{D}) |
| 6 | Expd(R_{D}) | 0 | R_{D} ⊕ Perm(R_{D}) | R_{D} ⊕ |
| | | | | Perm(R_{D}) |
| 7 | Expd(R_{D} ⊕ Perm(R_{D})) | 0 | R_{D} ⊕ Perm(R_{D}) | R_{D} |
| 8 | Expd(R_{D} ⊕ Perm(R_{D})) | 0 | R_{D} | R_{D} |
| 9 | Expd(R_{D}) | 0 | R_{D} | R_{D} ⊕ |
| | | | | Perm(R_{D}) |
| 10 | Expd(R_{D}) | 0 | R_{D} ⊕ Perm(R_{D}) | R_{D} ⊕ |
| | | | | Perm(R_{D}) |
| 11 | Expd(R_{D} ⊕ Perm(R_{D})) | 0 | R_{D} ⊕ Perm(R_{D}) | R_{D} |
| 12 | Expd(R_{D} ⊕ Perm(R_{D})) | 0 | R_{D} | R_{D} |
| 13 | Expd(R_{D}) | 0 | R_{D} | R_{D} ⊕ |
| | | | | Perm(R_{D}) |
| 14 | Expd(R_{D}) | R_{D} | R_{D} ⊕ Perm(R_{D}) | R_{D} ⊕ |
| | | | | Perm(R_{D}) |
| 15 | Expd(R_{D} ⊕ Perm(R_{D})) | R_{D} | Perm(R_{D}) | R_{D} |
| 16 | — | — | 0 | 0 |

As can be seen from the table, D is either R_{D} or 0. C can have three possible values, Expd(R_{D}), Expd(Perm(R_{D})) and Expd(R_{D}⊕Perm(R_{D})). Of these only the last requires additional hardware, ie. 32 XOR logic gates. The registers L and R are changed by three possible values, R_{D}, Perm(R_{D}) and R_{D}⊕Perm(R_{D}).

With reference now to FIGS. 9 and 10, a decryption round will now be described. Compared to the encryption operations, in decryption the left and right registers 14, 15 are reversed, and the 48-bit round keys RKₙ are applied in reverse order (RK₁₆ down to RK₁) to the XOR operation 23. FIG. 9 shows the conventional DES decryption operations.

FIG. 10 shows the corresponding decryption operation modified according to a preferred implementation of the invention, complementary to the encryption round of FIG. 8. The same correction terms are applied to obtain C and D.

Triple DES Algorithm Implementation

A preferred implementation has been described adapted for the DES algorithm. The invention can also be applied to the triple DES algorithm.

Triple DES encryption consists of three parts: the 16 encryption rounds of DES, followed by 16 decryption rounds with a different set of round keys and 16 further encryption rounds with yet another set of encryption round keys.

In one embodiment of the invention, the constants C and D can be used for each of the three parts. However, it is noted that at the end of each part, the registers L and R are not modified by a random value thereby introducing a possible vulnerability to attack.

Thus, in a further preferred embodiment, the constants C and D are modified slightly for a triple DES implementation. The constant D is kept as zero for all rounds except the last two rounds of the third part. In such a case, the four round pattern in Table 1 is repeated also for rounds 16 and 32. At round 16 both the L and R registers differ from a conventional triple DES implementation by the random value R_{D}. Interchanging these values, because of the subsequent decryption round, makes no difference to the generation of the correction terms C and D.

The same is true at the transition to the third part, ie. round 32. To obtain a correct value in the L and R registers at the end of the encryption, we must make C₄₆ and D₄₆ respectively equal to C₁₄ and D₁₄ as shown in table 1, and likewise, C₄₇ and D₄₇ respectively equal to C₁₅ and D₁₅.

In practice, R_{D} can be generated from a 32-bit linear feedback shift register. After reset, it will run for a certain random time period, according to a predetermined protocol. Alternatively, R_{D} may be generated by any kind of random generator.

The value of R_{D} is updated after a predetermined number of encryptions or decryptions, depending on the risk of an attack, or in accordance with the user's preference. At that time, the S-boxes are again re-loaded with data XOR-combined with R_{D} and addresses XOR-combined with R_{A}=Expd(Perm(R_{D})). It will be understood that more frequent reloading of the S-boxes with freshly encrypted data increases the security of the cryptographic system at the expense of increased processing time.

Calculation of Constants C and D

In the following, the values for normal DES are indicated with a quote (′). This makes it easier to see what has to be corrected.

For the normal S-Boxes applies:
SBoxInₙ′=Expd(Rₙ′)⊕RKₙ
Rₙ′=Perm(SBoxₙ₋₁)′⊕L′ₙ₋₁
Lₙ′=Rₙ₋₁′

The contents and addressing of the original and modified S-Boxes have the following relation:
1. SBoxInₙ′=SBoxInₙ⊕R_{A}
2. SBoxₙ′=SBoxₙ⊕R_{D}

For the modified DES scheme applies:

$$\begin{matrix}{R}_{n} = {L}_{n - 1} ⊕ Perm ( {SBox}_{n - 1} ) \\ = {L}_{n - 1} ⊕ Perm ( {SBox}_{n - 1}^{′} ) ⊕ Perm ( {R}_{D} ) \\ = {R}_{n}^{′} ⊕ {L}_{n - 1}^{′} ⊕ {L}_{n - 1} ⊕ Perm ( {R}_{D} ) \\ {L}_{n} = {R}_{n - 1} ⊕ {D}_{n - 1} \\ {SBoxIn}_{n} = Expd ( {R}_{n} ) ⊕ R {K}_{n} ⊕ {C}_{n} \\ = Expd ( {R}_{n} ) ⊕ R {K}_{n} ⊕ {C}_{n} ⊕ Expd ( {R}_{n}^{′} ) ⊕ R {K}_{n} ⊕ {SBoxIn}_{n} ⊕ {R}_{A} \\ Therefore , \\ {C}_{n} = Expd ( {R}_{n} ) ⊕ Expd ( {R}_{n}^{′} ) ⊕ {R}_{A} \\ = Expd ( {L}_{n - 1}^{′} ⊕ {L}_{n - 1} ) ⊕ Expd ( Perm ( {R}_{D} ) ) ⊕ {R}_{A}\end{matrix}$$

We choose D=R_{D} for rounds 1 and 2 and D=0 for the remaining rounds, except for the last 2 rounds. Furthermore, we choose: Expd(Perm(R_{D}))=R_{A}.

Now, we have found the following relations:
Rₙ=R′ₙ⊕L′ₙ₋₁⊕Lₙ₋₁⊕Perm(R_{D})
Lₙ=Rₙ₋₁⊕Dₙ₋₁
Cₙ=Expd(Lₙ₋₁⊕Lₙ₋₁) for n>0
C₀=R_{A}=Expd(Perm(R_{D}))

Further, we have the following requirements because of DPA:
Lₙ≠Lₙ′ except for n=0 and n=16
Rₙ≠Rₙ′ except for n=0 and n=16
Rₙ=R′ₙ⊕L′ₙ₋₁⊕Lₙ₋₁⊕Perm(R_{D})
Lₙ=Rₙ₋₁⊕Dₙ₋₁

$$\begin{matrix}{R}_{n + 1} = {R}_{n + 1}^{′} ⊕ {L}_{n}^{′} ⊕ {L}_{n} ⊕ Perm ( {R}_{D} ) \\ {L}_{n + 1} = {R}_{n} ⊕ {D}_{n} \\ = {R}_{n}^{′} ⊕ {L}_{n - 1}^{′} ⊕ {L}_{n - 1} ⊕ Perm ( {R}_{D} ) ⊕ {D}_{n} \\ = {L}_{n + 1}^{′} ⊕ {L}_{n - 1}^{′} ⊕ {L}_{n - 1} ⊕ Perm ( {R}_{D} ) ⊕ {D}_{n} \\ {R}_{n + 1} ⊕ {R}_{n - 1}^{′} = {L}_{n}^{′} ⊕ {L}_{n} ⊕ Perm ( {R}_{D} ) \\ {L}_{n + 1} ⊕ {L}_{n + 1}^{′} = {L}_{n - 1}^{′} ⊕ {L}_{n - 1} ⊕ Perm ( {R}_{D} ) ⊕ {D}_{n} \\ {R}_{n + 2} ⊕ {R}_{n + 2}^{′} = {L}_{n + 1}^{′} ⊕ {L}_{n + 1} ⊕ Perm ( {R}_{D} ) \\ = {L}_{n - 1}^{′} ⊕ {L}_{n - 1} ⊕ {D}_{n} \\ {L}_{n + 2} ⊕ {L}_{n + 2}^{′} = {L}_{n}^{′} ⊕ {L}_{n} ⊕ Perm ( {R}_{D} ) ⊕ {D}_{n + 1} \\ {R}_{n + 3} ⊕ {R}_{n + 3}^{′} = {L}_{n + 2}^{′} ⊕ {L}_{n + 2} ⊕ Perm ( {R}_{D} ) \\ = {L}_{n}^{′} ⊕ {L}_{n} ⊕ {D}_{n + 1} \\ = {R}_{n - 1}^{′} ⊕ {R}_{n - 1} ⊕ {D}_{n - 1} ⊕ {D}_{n + 1} \\ {L}_{n + 3} ⊕ {L}_{n + 3}^{′} = {L}_{n + 1}^{′} ⊕ {L}_{n + 1} ⊕ Perm ( {R}_{D} ) ⊕ {D}_{n + 2} \\ = {L}_{n - 1}^{′} ⊕ {L}_{n - 1} ⊕ {D}_{n} ⊕ {D}_{n + 2}\end{matrix}$$

There is a repetition after 4 rounds, except for the constants.
Rₙ₊₃⊕R′ₙ₊₃=R′ₙ₋₁⊕Rₙ₋₁⊕Dₙ₋₁⊕Dₙ₊₁
Lₙ₊₃⊕L′ₙ₊₃=L′ₙ₋₁⊕Lₙ₋₁⊕Dₙ⊕Dₙ₊₂

If we know the relations for the first 4 rounds, then we know them for all rounds:
R₀⊕R₀′=0
L₀⊕L₀′=0

For the 3 following rounds, we use the formulae:
Rₙ₊₁⊕R′ₙ₊₁=Lₙ⊕L′ₙ⊕Perm(R_{D})
Lₙ₊₁⊕L′ₙ₊₁=Rₙ⊕R′ₙ⊕Dₙ

Round 1 D₀=R_{D}
R₁⊕R′₁=L₀⊕L′₀⊕Perm(R_{D})=Perm(R_{D})
L₁⊕L′₁=R₀_61 R′₀⊕D₀=R_{D}

Round 2 D₁=R_{D}
R₂⊕R′₂=L₁⊕L′₁⊕Perm(R_{D})=R_{D}⊕Perm(R_{D})
L₂⊕L′₂=R₁⊕R′₁⊕D₁=R_{D}=R_{D}⊕Perm(R_{D})

Round 3 D₂=0
R₃⊕R′₃=L₂⊕L′₂⊕Perm(R_{D})=R_{D}
L₃⊕L′₃=R₂⊕R′₂⊕D₂=R_{D}⊕Perm(R_{D})

For the following rounds we will use the formulae:
Rₙ₊₃₊⊕R′ₙ₊₃=Rₙ₌₁⊕R′ₙ₋₁⊕Dₙ₋₁⊕Dₙ₊₁
Lₙ₊₁⊕L′ₙ₊₁=Rₙ₋₁⊕R′ₙ₋₁⊕Dₙ

Round 4, 8 and 12 D₃=0; D₇=0; D₁₃=0:
R₄⊕R′₄=R₀⊕R′₀⊕D₀⊕D₂=R_{D}
L₄⊕L′₄=R₃⊕R′₃⊕D₃=R_{D}

Round 5, 11 D₄=0; D₈=0
R₅⊕R′₅=R₁⊕R′₁⊕D₁⊕D₃=Perm(R_{D})⊕R_{D}
L₅⊕L′₅=R₄⊕R′₄⊕D₄=R_{D}

Round 6, 10 and 14 D₅=0; D₉=0; D₁₃=0
R₆⊕R′₆=R₂=R′₂⊕D₂⊕D₄=Perm(R_{D})⊕R_{D}
L₆⊕L₆=R₅⊕R′₅⊕D₅=R_{D}⊕Perm(R_{D})

Round 7 and 11 D₆=0; D₁₀=0
R₇⊕R′₇=R₃⊕R′₃⊕D₃⊕D₅=R_{D}
L₇⊕L′₇=R₆⊕R′₆⊕D₆=R_{D}⊕Perm(R_{D})

We want at the end, that L₁₆=L′₁₆ and R+16+=R′₁₆

Round 15 D₁₄=R_{D}
R₁₅⊕R′₁₅=R₁₁⊕R′₁₁⊕D₁₁⊕D₁₃=R_{D}
L₁₅⊕L′₁₅=R₁₄⊕R′₁₄⊕D₁₄=Perm(R_{D})

Round 16 D₁₅=R_{D}
R₁₆⊕R′₁₆=R₁₂⊕R′₁₂⊕D₁₂⊕D₁₄=R_{D}⊕D₁₄=0
L₁₆⊕L′₁₆=R₁₅⊕R′₁₅⊕D₁₅=R_{D}⊕D₁₅=0

The S-Boxes are conventionally implemented in random access memory (RAM) but may alternatively be implemented using presettable latches, which do not need to be loaded from ROM or flash memory.

After preset (where the latches have a predefined initial state), the S-Boxes are loaded, such that at address A⊕R_{A} the data are exored with R_{D}, but R_{A} and R_{D} are at preset fixed data values (which might be zero) instead of random data values.

Instead of using data from ROM or Flash memory, the data from the S-Boxes are used for reloading with encrypted data (R_{D}′) at address A+R_{A}′.

Therefore, we need a 5-bit address counter (A) and two 32-bit registers (D₀ and D₁) to temporarily store intermediate data, according to the following algorithm:

```
for A = 0 to 31 do
{ D₀ = SBox{A]
      D₁ = SBox[A ⊕ R_{A} ⊕ R_{A}′]
      SBox[A] = D₁ ⊕ R_{D} ⊕ R_{D}′
      SBox[A ⊕ R_{A} ⊕ R_{A}′] = D₀ ⊕ R_{D} ⊕ R_{D}′
}
```

In words, for every address in the range of 0 . . . 31, we read the S-Boxes both at address A and address A ⊕R_{A}⊕R_{A}′ and store the data in D₀ and D₁. Then we write the new encrypted data D₁⊕R_{D}⊕R_{D}′ to address A and the new encrypted data D₀⊕R_{D}⊕R_{D}′ to address A⊕R_{A}⊕R_{A}′. This has the effect that the address is scrambled with R_{A}′ instead of R_{A} and the data with R_{D}′ instead of R_{D}. The only requirement is that the most significant bit of R_{A} and R_{A}′ differs, such that A⊕R_{A}⊕R_{A}′ is always in the range 32 . . . 63.

Advanced Encryption Standard Implementation

The principle of the present invention is generally applicable to both the DES and AES algorithms.

The principles described above can thus be deployed in a modification of the AES algorithm. While the DES algorithm uses 8 S-boxes 50₀ . . . 50₇ each having six inputs and four outputs (shown schematically in FIG. 5), the AES algorithm uses 1 S-box with eight inputs and eight outputs. The 8 S-boxes 50₀ . . . 50₇ can be combined in such a way as to share the same memory, thereby saving hardware resources.

Such an S-Box implementation for AES is shown in FIG. 6. All inputs to the S-boxes 60₀ . . . 60₇ are the same, corresponding to the lowest six bits of the address, Dᵢₙ(5:0). The even numbered S-boxes 60₀, 60₂, 60₄ . . . give the data outputs 7:4 and the odd numbered S-boxes 60₁, 60₃, 60₅ . . . give the outputs 3:0. A multiplexer 62 multiplexes the eight outputs of each S-box pair, while the highest two bits of the address input, Dᵢₙ(7:6) select which pair of S-box outputs is actually used to generate the eight bit output, Dₒᵤₜ(7:0).

FIG. 11 shows a schematic diagram of a preferred embodiment of an AES encryption operation using an encrypted S-box according to the present invention. In the diagram, it will be understood that the procedural steps 100 to 109 correspond to the conventional procedural steps of the AES encryption algorithm, to which the steps 110 to 112 have been added in accordance with a preferred embodiment of the present invention. In other words, if the address modification constant C is 0 at steps 110 and 111, and the data modification constant D is 0 at step 112, then the procedure reduces to the conventional AES encryption algorithm.

Plaintext input block 100 is provided as input to the AddRoundKey transform 101 in the initial round of the encryption algorithm. The AddRoundKey transform comprises the step of XOR-combining the 128-bit input block 100 with the 128-bit RoundKey, and constitutes the first round of the AES algorithm.

For each subsequent round (of which there are nine for an input block comprising 128 bits) except the last round, the round procedure 115 comprises: (i) the SubBytes transform 102, which is conventionally executed as an S-box look-up operation which implements both the Multiplicative Inverse and Affine transformations; (ii) the ShiftRows transform 103 which comprises a circular left shift of each row in the 16-byte (128-bit) block represented as a 4×4 matrix; (iii) the MixColumns transform 104 that transforms each column according to a predefined polynomial function; and (iv) the AddRoundKey transform 105 that generates the new round key for the subsequent round by XOR-combination of the output from the MixColumns transform with the current round key.

This procedure 115 is executed nine times (under the control of decision box 106) before entering the final round 120, in which the MixColumns transform is omitted.

Similar to the DES embodiment described earlier, the S-boxes used in the SubBytes transform 102 have been modified according to an address modification function. In the preferred embodiment described, the address modification function comprises XOR-combination of the address of the look-up table with a random value R_{A}. Similarly, the data in the S-box have been modified according to a data modification function. In the preferred embodiment, the data modification function comprises XOR-combination of the data with a random value R_{D}.

Because of the modified contents of the SubBytes S-box, the following relations must be fulfilled:
SubBytes look-up address, b_{r,c}=b′_{r,c}⊕R_{A}
SubBytes output, c_{r,c}=c′_{r,c}⊕R_{D}

In the first round 101, the address modification constant C =R_{A}.

In subsequent rounds 115 numbered 2 . . . Nᵣ-1, where N is the number of rounds required for the input block 100 size, the output from the ShiftRows transform 103 is d =ShiftRows(c).

Since this operation only interchanges the bytes within a row, the data is not changed. Therefore,
d_{r,c}=d′_{r,c}⊕R_{D}

The output from the MixColumns transform, e =MixColumn(d).
e_{r,c}=e′_{r,c}⊕R_{D}.
a=e⊕RoundKey=e′⊕R_{D}⊕RoundKey=a′⊕R_{D}
b_{r,c}=a_{r,c}⊕C=a′_{r,c}⊕R_{D}⊕C
b_{r,c}=b′_{r,c}⊕R_{A}=a′_{r,c}⊕R_{A}, since C=O for standard AES.

It follows: R_{D}⊕C=R_{A}.
C=R_{D}⊕R_{A}

When we choose R_{D}=R_{A}, C=0, there is no correction to be made.

All data are XOR-combined with R_{D}. So when R_{D} is regularly changed, all data be randomly changed, making differential power analysis impossible.

In the final round, the output data has to become equal to the output of the standard AES algorithm. This means we have to add D=R_{D} to each byte.

In the described embodiment, the key is not changed.

During some cycles of the key scheduling, the key is subjected to the SubByte transform. In the preferred embodiment, the same hardware is used for this transform. In this case, before the key is input to the S-Box it is XOR-combined with R_{D} and the output is also XOR-combined with R_{D}.

In summary, in the preferred embodiment, we select R_{D}=R_{A}. In the first round, C=R_{D}. In the intermediate rounds C=0. In the last round D=R_{D}. All data compared to the standard AES algorithm differs by R_{D}. Thus, regular changing of R_{D} changes the data and will give different power analysis current traces.

FIG. 12 shows a schematic diagram of a preferred embodiment of a decryption operation using an encrypted S-box according to the present invention. In the diagram, it will be understood that the procedural steps 120 to 129 correspond to the conventional procedural steps of the AES decryption algorithm, to which steps 130 to 132 have been added in accordance with a preferred embodiment. In other words, if the address modification constant C is 0 at steps 130 and 131, and the data modification constant D is 0 at step 132, the procedure reduces to the conventional AES decryption algorithm.

Ciphertext input block 120 is provided as input to the AddRoundKey transform 121 in the initial round of the algorithm. The AddRoundKey transform comprises the step of XOR-combination of the 128-bit input block 100 with the 128-bit RoundKey, and constitutes the first round of the AES decryption algorithm.

For each subsequent round (of which there are nine for an input block comprising 128 bits) except the last round, the round procedure 135 comprises: (i) the InvShiftRows transform 122, which is the inverse to ShiftRows transform 103; (ii) the InvSubBytes transform 123 which is the inverse to SubBytes transform 102; (iii) the InvMixColumns transform 125 which is the inverse to the MixColumns transform 104; and (iv) the AddRoundKey transform 124 that generates the new round key for the subsequent round by XOR-combination of the output from the InverseSubBytes transform with the current round key.

This procedure 115 is executed nine times (under the control of decision box 126) before entering the final round 140, in which the InvMixColumns transform is omitted.

Similar to the DES embodiment described earlier, the S-boxes used in the InvSubBytes transform 123 have been modified according to an address modification function. In the preferred embodiment described, the address modification function comprises XOR-combination of the address of the look-up table with a random value R_{A}. Similarly, the data in the S-box have been modified according to a data modification function. In the preferred embodiment, the data modification function comprises XOR-combination of the data with a random value R_{D}.

Because of the modified contents of the InvSubBytes S-Box, the following relations have to be fulfilled:
c_{r,c}=c′_{r,c}⊕R_{A}
d_{r,c}=d′_{r,c}⊕R_{D}

In the first round, C=R_{A}.
a_{r,c}=a′_{r,c}
b_{r,c}=a_{r,c}⊕C=a′_{r,c}⊕C=b′_{r,c}⊕C, since a′_{r,c}=b′_{r,c}
c=InvShiftRows(b)

Since this operation only interchanges the bytes within a row, the data is not changed. Therefore,
c_{r,c}=c′_{r,c}⊕C.

So we have to choose C=R_{A} for the first round.

In each of the subsequent rounds 2 . . . Nᵣ-1, the output of the InvSubByte applies:
d_{r,c}=d′_{r,c}⊕R_{D}
e=d⊕RoundKey=d′⊕R_{D}⊕RoundKey=e′⊕R_{D}
a=InvMixColumns(e).
a_{r,c}=a′_{r,c}⊕R_{D}
b_{r,c}=a_{r,c}⊕C=a′_{r,c}⊕R_{D}⊕C=b′_{r,c}⊕R_{D}⊕C since b′_{r,c}=a′_{r,c}
c=InvShiftRows(b)

Since this operation only interchanges the bytes within a row, the data is not changed. Therefore,
c_{r,c}=c′_{r,c}⊕R_{D}⊕C.

This has to be: c_{r,c}=c′_{r,c}⊕R_{A}.

Now we choose as for encryption, C=0 and R_{D}=R_{A}

All data are XOR-combined with R_{D}. So when R_{D} is routinely changed at random, all data will also change at random, making differential power analysis impossible.

In addition, for the final round, we choose C=0. In this round, the output data has to become equal to the output of standard AES. This means we have to add D=R_{D} to each byte.

In some parts of the Key Scheduling, which is done in parallel to the decryption operations above, the Multiplicative Inverse followed by the Affine Transform is required, i.e. the encryption SubBytes transform. In preferred embodiments, it is desirable to use the same hardware to implement this transform. The procedural steps for this are shown in FIG. 13. First, the SubKey is XOR-combined with R_{D} (step 150). Then, an Affine Transform 151 is performed to annihilate the implicit Inverse Affine Transformation contained within the subsequent InvSubBytes transform 152 (corresponding to step 123 of FIG. 12). The output from this look-up operation is again subjected to an Affine Transform 153 and the operation completes with an XOR-combination 154 of the output with R_{D} to generate the new SubKey.

In summary, we choose R_{D}=R_{A}. In the first round, C=R_{D}. In all other rounds C=0. In the last round D=R_{D}. All data compared to the standard AES differs by R_{D}. So regularly changing R_{D} changes the data and will give different current traces.

The generation of R_{D} may be combined with a DES Engine. For this reason, R_{D} is chosen to be a 32-bit vector, although for DES it might also be a 4-times repeated byte. In practice, R_{D} can be generated from a 32-bit linear feedback shift register. After reset, it will run for a certain random time period, according to a predetermined protocol. Alternatively, R_{D} may be generated by any kind of random generator.

The value of R_{D} is preferably updated after one session (e.g. 16 encryption operations). Between sessions, it will run a fixed number of times. Then the S-Boxes are reloaded with data XOR-combined with the new value of R_{D} and the addresses XOR-combined with R_{A}=R_{D}.

It will be understood that the invention can readily be adapted to the 128-bit (as illustrated), 192-bit and 256-bit key size implementations of the AES algorithm, and also to other implementations of the Rijndael algorithm having different key and block sizes.

Other embodiments are within the scope of the appended claims.

1. A method of performing encryption or decryption in a cryptographic engine implementing a cryptographic algorithm, comprising the steps of:
retrieving data from an encrypted S-box, by performing an address modification function to modify an input address used for a look-up operation to said S-box, and performing a data modification function for modifying data output from said S-box as a result of said look-up operation, the address modification function and the data modification function being selected to compensate for the encryption of the S-box.

2. The method of claim 1 in which the address modification function comprises performing an XOR-combination of the input address with an address modification constant, R_{A}.

3. The method of claim 2 in which the data modification function comprises performing an XOR-combination of the output from the S-box with a data modification constant R_{D}.

4. The method of claim 3 applied to the DES algorithm, in which R_{D} is a random 32-bit value, and R_{A}=Expd(Perm(R_{D})).

5. The method of claim 1 further including at least one other data transformation step occurring between said address modification function and said look-up operation, the address modification function and the data modification function being adapted to also compensate for the effects of the at least one other data transformation step.

6. The method of claim 1 further including at least one other data transformation step occurring between said output of said look-up operation and said data modification function, the address modification function and the data modification function being adapted to also compensate for the effects of the at least one other data transformation step.

7. The method of claim 6 applied in the DES algorithm, in which the data modification function is applied to data being transferred from the right block R to the left block L for a subsequent encryption round.

8. The method of claim 7 in which the address modification function is applied immediately prior to the look-up operation to said S-box.

9. The method of claim 8 in which the data modification function comprises performing an XOR-combination of the right block data with data modification constant, D, and the address modification function comprises performing an XOR-combination of the S-box address with an address modification constant, C.

10. The method of claim 9 in which the values of C and D are selected, for each encryption round, according to the list in Table 1.

11. The method of claim 10, applied to each of the three stages of the triple DES algorithm, in which the values of C and D are modified so that D=R_{D} for rounds 1 and 2, D=0 for rounds 3 to 46, D=R_{D} for rounds 47, 48; C is unchanged except for C₄₆ and C₄₇ which are set to C₁₄ and C₁₅ respectively.

12. The method of claim 1 applied in the AES encryption algorithm in which the address modification function is applied to the data input to each SubBytes operation for successive rounds and the data modification function is applied in the final round.

13. The method of claim 1 applied in the AES decryption algorithm in which the address modification function is applied to the data input to each InvShiftRows operation for successive rounds and the data modification function is applied in the final round.

14. The method of claim 12 in which the address modification function comprises performing an XOR-combination of the input to the SubBytes transform with an address modification constant C, and the data modification function comprises performing an XOR-combination of the output of the AddRoundKey operation in the final round with a data modification constant, D.

15. The method of claim 14 in which the values of C are: R_{D} in the first encryption round and 0 in subsequent encryption rounds, and the value of D is selected as R_{D}.

16. The method of claim 13 in which the address modification function comprises performing an XOR-combination of the input to the InvShiftRows transform with an address modification constant C, and the data modification function comprises performing an XOR-combination of the output of the AddRoundKey operation in the final round with a data modification constant D.

17. The method of claim 16 in which the values of C are: R_{D} in the first decryption round and 0 in subsequent decryption rounds, and the value of D is selected as R_{D}.

18. The method of claim 1, further including the steps of periodically changing the address modification function and the data modification function for subsequent iterations of the encryption/decryption algorithm, the changes being selected to compensate for corresponding changes in the encryption of the S-box.

19. A method of performing encryption or decryption in a cryptographic engine implementing a cryptographic algorithm, comprising the steps of:
a) encrypting the data and address locations used to access said data in an S-box;
b) defining a corresponding address modification function and a data modification function to compensate for the encryption of data and address locations in the S-box;
c) retrieving data from the encrypted S-box, using said address modification function to modify an input address used for a look-up operation to said S-box, and performing the data modification function for modifying data output from said S-box as a result of said look-up operation; and
d) periodically repeating steps a)-c) with new encryption functions.

20. A cryptographic engine comprising:
an encrypted S-box providing predetermined data output as a function of input values, in accordance with a predetermined cryptographic transform, superimposed with an encryption function;
means for retrieving data from the encrypted S-box, by performing an address modification function to modify an input address used for a look-up operation to said S-box, and
means for performing a data modification function for modifying data output from said S-box as a result of said look-up operation, the address modification function and the data modification function being selected to compensate for the encryption of the S-box.

21. The cryptographic engine of claim 20 further including means for periodically applying a new encryption function to the S-box and updating the address modification function and data modification function to correspond thereto.

22. The cryptographic engine of claim 20 provided in a smartcard device.

23. A computer program product, comprising a computer readable medium having thereon computer program code means adapted, when said program is loaded onto a computer, to make the computer execute the procedure of claim 1.

24. A computer program, distributable by electronic data transmission, comprising computer program code means adapted, when said program is loaded onto a computer, to make the computer execute the procedure of claim 1.
